(19) United States
(12) Patent Application Publication
(10) Pub. No.: US 2010/0007702 A1
(43) Pub. Date: Jan. 14, 2010

(54) LIQUID CONTAINER, LIQUID JETTING APPARATUS, AND LIQUID JETTING SYSTEM

(76) Inventor: Yasuhiko Kosugi, Hata-machi (JP)

Correspondence Address: STROOCK & STROOCK & LAVAN LLP, 180 MAIDEN LANE, NEW YORK, NY, 10038, US

(21) Appl. No.: 12/500,128

(22) Filed: Jul. 9, 2009

(30) Foreign Application Priority Data
Jul. 11, 2008 (JP) 2008-181001

(51) Int. Cl. B41J 2/14

(52) U.S. Cl. 347/50

(57) ABSTRACT

A liquid container mountable on a liquid jetting apparatus, comprises: an electrical circuit including a first electrical device and a second electrical device; a first terminal; a second terminal; and a third terminal. The electrical circuit being constituted such that the liquid jetting apparatus is able: to execute sending of signals to the first electrical device and sending of signals to the second electrical device using a terminal potential difference which is a difference between electric potential inputs to the first and second terminals, to selectively execute either one of the sending of signals to the first electrical device and the sending of signals to the second electrical device by using different magnitudes of the terminal potential difference, and to execute receiving of signals from the first electrical device via the third terminal.

### TECHNICAL FIELD

The present application claims the priority based on Japanese Patent Application No. 2008-181001 filed on Jul. 11, 2008, the disclosure of which is hereby incorporated by reference in its entirety.

The present invention relates to a liquid container, a liquid jetting apparatus, and a liquid jetting system, and particularly to a liquid container having a plurality of electrical devices, a liquid jetting apparatus using this liquid container, and a liquid jetting system including this liquid container.

### BACKGROUND ART

Liquid containers are used for liquid jetting apparatuss including inkjet printers, to supply the liquid to be sprayed.

In the past, as a method of managing the remaining amount of liquid inside the liquid container, a method is known whereby control is done by calculating the amount of liquid sprayed using software, or a method whereby a liquid remaining volume sensor is provided in the liquid container. As an example of the latter, known is a liquid remaining volume sensor including a piezoelectric element (e.g. JP 2001-146030 A). This sensor determines the liquid remaining volume within the liquid container using the fact that the resonance frequency of the residual vibration signal due to the residual vibration (free vibration) of the vibration plate after forced vibration changes between a case when there is liquid and when there is no liquid inside a cavity facing opposite the vibration plate on which a piezoelectric element is layered.

Also, there are cases when the liquid container is further equipped with a memory for storing information relating to the liquid such as the liquid remaining volume or the liquid consumed volume. In this way, when the liquid container is equipped with both a liquid remaining volume sensor and memory, a typical example is when a terminal for the liquid jetting apparatus and the liquid remaining volume sensor to communicate and a terminal for the liquid jetting apparatus and the memory to communicate are provided independently at the electrically connected part between the liquid jetting apparatus and the liquid container (e.g. JP 2007-196664 A).

However, the increase in the number of terminals had the risk of bringing an increase in the number of parts and a decrease in the reliability of the connections between terminals. This kind of problem is not limited to liquid containers equipped with a sensor that includes a piezoelectric element and with a memory, but is also a problem common to liquid containers equipped with a first electrical device and a second electrical device.

### SUMMARY

An object of the present invention is to reduce the number of terminals for accessing the first electrical device and the second electrical device.

The present invention may be realized as the following modes or application examples to address at least part of the problems described above.

### APPLICATION EXAMPLE 1

A liquid container mountable on a liquid jetting apparatus, comprising: an electrical circuit including a first electrical device and a second electrical device; a first terminal; a second terminal; and a third terminal, the electrical circuit being constituted such that the liquid jetting apparatus is able: to execute sending of signals to the first electrical device and sending of signals to the second electrical device using a terminal potential difference which is a difference between electric potential inputs to the first and second terminals, to selectively execute either one of the sending of signals to the first electrical device and the sending of signals to the second electrical device by using different magnitudes of the terminal potential difference, and to execute receiving of signals from the first electrical device via the third terminal.

With this arrangement, it is possible to selectively execute either one of the sending of signals to the first electrical device and the sending of signals to the second electrical device using the first and second terminals, and it is possible to reduce the number of terminals of the liquid container accordingly.

### APPLICATION EXAMPLE 2

The liquid container according to Application Example 1, wherein the electrical circuit is further constituted such that the liquid jetting apparatus is able to supply drive power to the first electrical device via the first terminal.

With this arrangement, it is possible to supply the drive power to the first electrical device using the first and second terminals, and it is further possible to reduce the number of terminals accordingly.

### APPLICATION EXAMPLE 3

The liquid container according to Application Example 1 or 2, wherein the electrical circuit further includes a permission circuit that permits a variation in the terminal potential difference to be supplied to the first electrical device if the terminal potential difference exceeds a threshold value.

With this arrangement, the variation of the terminal potential difference that does not exceed the threshold value is not supplied to the first electrical device, so it is possible to suppress the first electrical device having faulty operation due to variation of the terminal potential difference which is lower than the threshold value.

### APPLICATION EXAMPLE 4

The liquid container according to any one of Application Example 1 through 3, wherein the permission circuit includes a Zener diode.

With this arrangement, it is possible to easily constitute a permission circuit.

### APPLICATION EXAMPLE 5

The liquid container according to any one of Application Example 1 through 4, wherein the electrical circuit is further constituted such that the liquid jetting apparatus is able to detect whether or not the liquid container is mounted on the liquid jetting apparatus via the third terminal.

### APPLICATION EXAMPLE 6

The liquid container according to any one of Application Example 1 through 5, wherein the first electrical device further includes a memory, the sending of signals to the first electrical device includes sending of signals for at least one of writing to the memory or reading from the memory, and a magnitude of the terminal potential difference for the sending of signals to the first electrical device is greater than a magnitude of the terminal potential difference for the sending of signals to the second electrical device.

With this arrangement, it is possible to selectively execute either of the communication with the second electrical device and access to memory using the first and second terminals, and it is possible to reduce the number of terminals of the liquid container accordingly.

### APPLICATION EXAMPLE 7

The liquid container according to any one of Application Example 1 through 6, wherein the second electrical device includes an oscillation circuit, communication between the ink jetting apparatus and the second electrical device includes sending of a drive signal to the oscillation circuit from the liquid jetting apparatus, and receiving of a response signal from the oscillation circuit by the liquid jetting apparatus, and a magnitude of the terminal potential difference for the sending of signals to the second electrical device is smaller than a magnitude of the terminal potential difference for the sending of signals to the first electrical device.

With this arrangement, it is possible to selectively execute either of the exchange of signals with the oscillation circuit and the sending of signals to the first electrical device using the first and second terminals, and it is possible to reduce the number of terminals of the liquid container accordingly.

### APPLICATION EXAMPLE 8

The liquid container according to any one of Application Example 1 through 5, wherein the first electrical device includes a memory, the sending of signals to the first electrical device includes sending of signals for at least one of writing to the memory and reading from the memory, the second electrical device includes an oscillation circuit, and communication between the ink jetting apparatus and the second electrical device includes sending of a drive signal to the oscillation circuit from the liquid jetting apparatus, and receiving of a response signal from the oscillation circuit by the liquid jetting apparatus.

With this arrangement, it is possible to selectively execute either of the exchange of signals with the oscillation circuit and accessing of the memory using the first and second terminals, and it is possible to reduce the number of terminals of the liquid container accordingly.

### APPLICATION EXAMPLE 9

The liquid container according to Application Example 8, wherein a magnitude of the terminal potential difference for the sending of signals to the memory is larger than a magnitude of the terminal potential difference for the sending of signals the oscillation circuit.

### APPLICATION EXAMPLE 10

The liquid container according to Application Example 8, wherein the electrical circuit further includes a regulator that is connected to the first terminal in parallel with the oscillation circuit, and that converts a voltage input to the first terminal into a drive power supply for the memory and supplies the same to the memory.

With this arrangement, it is possible to drive the memory with voltage input to the first terminal as the power supply.

### APPLICATION EXAMPLE 11

The liquid container according to Application Example 10, wherein the electrical circuit further includes a Zener diode disposed between the first terminal and the regulator.

With this arrangement, the communication signals with the oscillation circuit with a voltage smaller than the breakdown voltage of the Zener diode are not supplied to the regulator, so it is possible to suppress faulty operation of the regulator. As a result, it is possible to suppress faulty operation of the memory.

### APPLICATION EXAMPLE 12

The liquid container according to Application Example 8, wherein the electrical circuit further includes: a plurality of comparators whose outputs are supplied to the memory; and wiring connected to the first terminal in parallel to the oscillation circuit, and connected to a respective one of input terminals of the plurality of comparators.

With this arrangement, it is possible for the memory to detect the terminal potential difference via the comparators. As a result, it is possible to realize sending of data to memory with a simple constitution using the first terminal and the second terminal.

### APPLICATION EXAMPLE 13

The liquid container according to Application Example 12, wherein the electrical circuit further includes a Zener diode disposed between the first terminal and the respective one of input terminals of the plurality of comparators.

With this arrangement, the communication signals with the oscillation circuit with a voltage smaller than the breakdown voltage of the Zener diode are not supplied to the comparator, so it is possible to suppress faulty operation of the comparator. As a result, it is possible to suppress faulty operation of the memory.

### APPLICATION EXAMPLE 14

The liquid container according to Application Example 8, wherein the electrical circuit further includes: a regulator that is connected to the first terminal in parallel with the oscillation circuit, and that converts a voltage input to the first terminal into a drive power supply for the memory and supplies the same to the memory, a plurality of comparators whose outputs are supplied to the memory; and wiring connected to the first terminal in parallel to the oscillation circuit, and connected to a respective one of input terminals of the plurality of comparators; and a voltage divider circuit that divides a voltage of the drive power supply supplied by the regulator, and inputs the divided voltages to a respective another one of input terminals of the plurality of comparators.

With this arrangement, it is possible to supply a stable drive power to the memory using the terminal potential difference between the first and second terminals, and it is also possible to realize sending of data to the memory with a simple constitution.

### APPLICATION EXAMPLE 15

The liquid container according to Application Example 8, wherein the electrical circuit further includes a transistor having a control electrode to which an output from the memory is input, and the electrical circuit is constituted such that a voltage of the third terminal varies depending on whether the transistor is in an ON state or an OFF state, and the liquid jetting apparatus is able to execute reading from the memory based on detection of variation of the voltage of the third terminal.

With this arrangement, it is possible to realize receiving of data from the memory using a simple constitution using the third terminal.

### APPLICATION EXAMPLE 16

The liquid container according to Application Example 8, wherein the electrical circuit further includes a Zener diode disposed between the second terminal and the memory.

With this arrangement, for example even if the terminal potential difference between the first and second terminals becomes a negative value, it is possible to suppress supplying of the negative value potential difference between terminals to the memory using the Zener diode. As a result, it is possible to suppress damage or faulty operation of the memory.

### APPLICATION EXAMPLE 17

The liquid container according to Application Example 7 or 8, wherein the oscillation device includes a piezoelectric element, and the piezoelectric element is used for detection of a residual amount of liquid in the liquid container.

With this arrangement, it is possible to perform detection of the residual amount of liquid using the piezoelectric element.

### APPLICATION EXAMPLE 18

The liquid container according to Application Example 7 or 8, wherein the oscillation device outputs the response signal indicating that there exists liquid in the liquid container regardless of an actual residual amount of liquid in the liquid container.

### APPLICATION EXAMPLE 19

A liquid jetting apparatus on which is mountable a liquid container including an electrical circuit that includes a first electrical device and a second electrical device, a first terminal, a second terminal, and a third terminal, the liquid jetting apparatus comprising: a first communication processing unit that supplies a reference potential to the second terminal, sends first signals to the first electrical device via the first terminal, and receives second signals from the first electrical device via the third terminal; and a second communication processing unit that sends and receives third signals via the first terminal and the second terminal to communicates with the second device, and wherein a voltage of the first signals and a voltage of the third signals have different magnitudes.

With this arrangement, it is possible to selectively execute either of the sending of signals to the first electrical device and the sending of signals to the second electrical device using the first and second terminals, so it is possible to reduce the number of terminals of the liquid container.

The present invention may be realized with various modes, and can be realized as a liquid supply device for supplying liquid to a liquid jetting apparatus, a board on which the liquid container is mounted, an electrical circuit placed in the liquid container, and a liquid jetting system.

### BRIEF DESCRIPTION OF THE DRAWINGS

FIG. 1 is an explanatory drawing showing the schematic structure of a printing system of the first embodiment;

FIG. 2 is an exploded perspective view showing the schematic structure of the ink cartridge;

FIG. 3 is an expanded exploded perspective view of the front surface side of the ink cartridge;

FIGS. 4A and 4B are drawings explaining the circuit board;

FIG. 5 is a first explanatory drawing showing the electrical constitution of the printer of the first embodiment;

FIG. 6 is a second explanatory drawing showing the electrical configuration of the printer of the first embodiment;

FIG. 7 is a timing chart of the residual ink amount determination process of the first embodiment;

FIG. 8 is a timing chart of the memory access process when writing data to the storage device;

FIG. 9 is a timing chart of the memory access process when reading data from the storage device;

FIG. 10 is a first explanatory drawing showing the electrical configuration of the printer of the second embodiment;

FIG. 11 is a second explanatory drawing showing the electrical configuration of the printer of the second embodiment;

FIG. 12 is an explanatory drawing showing the electrical configuration of the printer of the third embodiment; and

FIG. 13 is an explanatory drawing showing the electrical configuration of the printer of the fourth embodiment.

### DESCRIPTION OF THE EMBODIMENT

### A. First Embodiment

### Constitution of the Printing System:

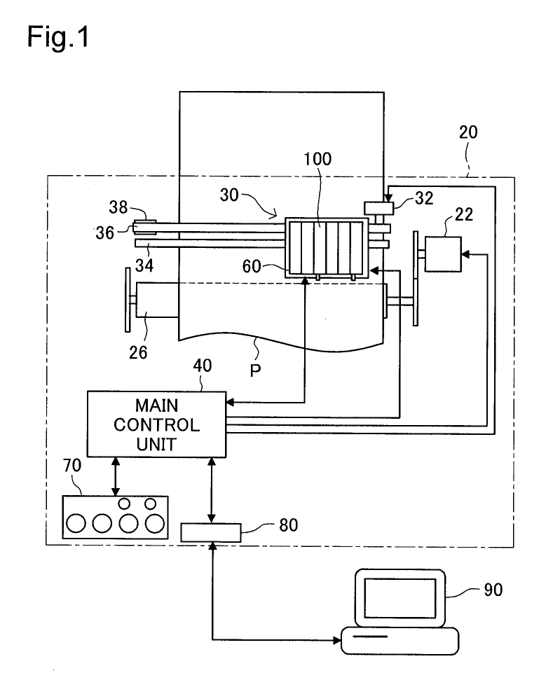

Next, we will describe modes of carrying out the present invention based on embodiments. FIG. 1 is an explanatory drawing showing the schematic structure of a printing system of the first embodiment. The printing system is equipped with a printer 20, a computer 90, and an ink cartridge 100. The printer 20 is connected to the computer 90 via a connector 80.

The printer 20 is equipped with a sub scan feed mechanism, a main scan feed mechanism, a head driving mechanism, and a main control unit 40 for controlling each mechanism. The sub scan feed mechanism is equipped with a paper feed motor 22 and a platen 26, and paper P is transported in the sub scan direction by the rotation of the paper feed motor being transmitted to the platen. The main scan feed mechanism is equipped with a carriage motor 32, a pulley 38, a drive belt 36 provided extending between the carriage motor 32 and the pulley 38, and a sliding shaft 34 provided in parallel to the axis of the platen 26. The sliding shaft 34 is held to be able to slide the carriage 30 fixed to the drive belt 36. The rotation of the carriage motor 32 is transmitted to the carriage 30 via the drive belt 36, and the carriage 30 moves back and forth in the axis direction (main scan direction) of the platen 26 along the sliding shaft 34. The head driving mechanism is equipped with a printing head unit 60 placed on the carriage 30, and drives the printing head to spray ink on the paper P. As will be described later, a plurality of ink cartridges can be mounted so as to be freely detachable on the printing head unit 60. The printer 20 is further equipped with an operating unit 70 for the user to perform various settings of the printer and to confirm the printer status.

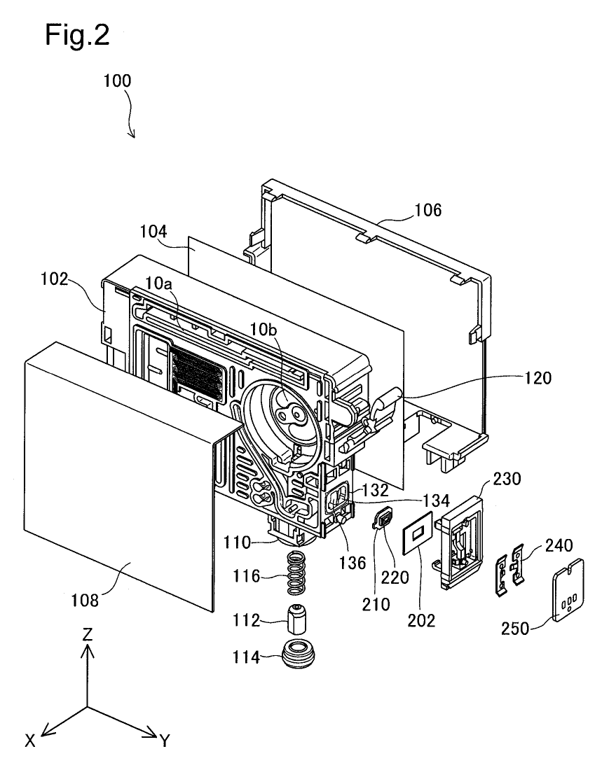

FIG. 2 is an exploded perspective view showing the schematic structure of the ink cartridge 100. The vertical direction for which the ink cartridge 100 is in a state mounted on the carriage 30 matches the Z axis direction in FIG. 2.

The ink cartridge 100 is equipped with a container main unit 102, a first film 104, a second film 108, and a lid unit 106. These members are formed by a resin that can be heat welded together, for example. A liquid supply portion 110 is formed on the bottom surface of the container main unit 102. In sequence from the bottom surface side, a seal member 114, a spring seat 112, and a restricting spring 116 are stored inside the liquid supply portion 110. When the ink take-up needle (not illustrated) of the printing head unit 60 is inserted in the liquid supply portion 110, sealing is done so that a gap does not occur between the inner wall of the liquid supply portion 110 and the outer wall of the ink take-up needle. The restricting spring 116 causes a pressing force in the direction that will make the spring seat 112 contact the inner wall of the seal member 114. When the ink supply needle is inserted in the liquid supply portion 110, the top end of the ink supply needle pushes up the spring seat 112, a gap occurs between the spring seat 112 and the seal member 114, and ink is supplied from that gap to the ink supply needle.

The container main unit 102 is provided with flow path forming portions having various shapes such as a rib 10a on the first main surface (surface on the X axis forward direction side), second main surface (surface on the X axis back direction side), and front surface (surface on the Y axis forward direction side) of the container main unit 102. The first film 104 and the second film 108 are adhered to the container main unit 102 so as to entirely cover the first and second main surfaces of the container main unit 102. The first film 104 and the second film 108 are tightly adhered so that a gap does not occur with the edges of the flow path forming portions of the container main unit 102. With these flow path forming portions and the first film 104 and the second film 108, liquid flow paths such as a plurality of small chambers or narrow flow paths are partition-formed inside the ink cartridge 100. Note that a negative pressure generating valve is arranged between the valve chamber 10b formed on the container main unit 102 as part of the flow path forming portions and the second film 108, but to avoid making the drawing too complex, this is omitted in the illustration. The lid unit 106 is mounted on the second main surface side of the container main unit 102 so as to cover the first film 104.

The fluid flow path formed on the ink cartridge 100 has one end linked to the air, and the other end linked to the liquid supply portion 110. Specifically, the ink cartridge 100 is an air linked type ink cartridge 100 for which air is introduced to the liquid flow path according to the supply of ink to the printer 20, but a detailed explanation of the liquid flow path has been omitted.

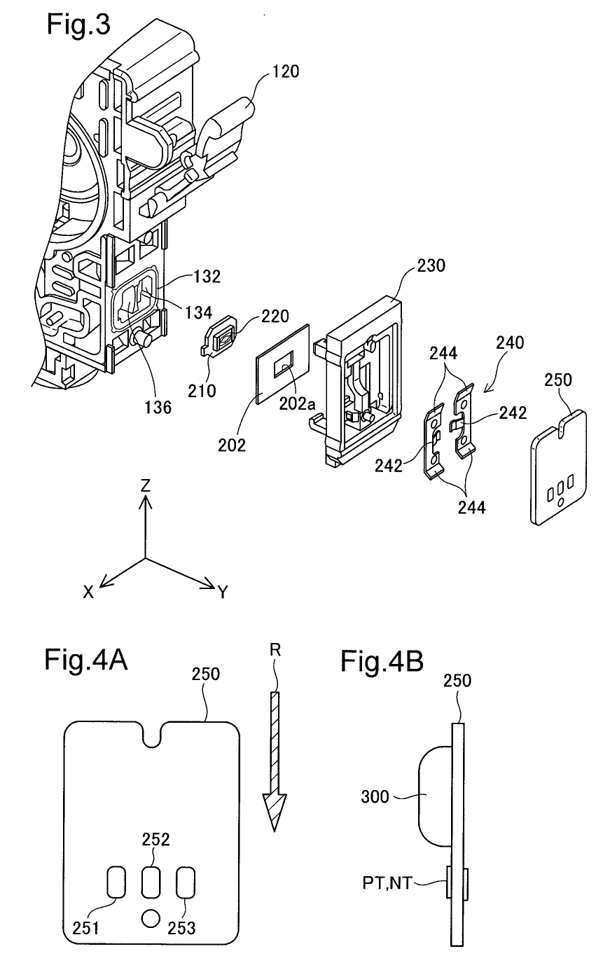

FIG. 3 is an expanded exploded perspective view of the front surface side of the ink cartridge 100. A lever 120 that engages in the holder side provided in the printing head unit 60 is provided on the front surface of the container main unit 102. For example, at the lower position of the lever 120, a base member holder 134 which is part of the flow path forming portions is opened. A weld rib 132 is formed on the periphery of the opening of the base member holder 134. A partition wall 136 that partitions the liquid flow path formed by the base member holder 134 into the upstream side flow path and the downstream side flow path is formed in the base member holder 134.

Near the base member holder 134 of the container main unit 102, mounted in the following order are a sensor base member 210, a sensor chip 220 including a piezoelectric element, a weld film 202, a cover 230, a relay terminal 240, and a circuit board 250.

FIGS. 4A and 4B are drawings explaining the circuit board 250. A first terminal 251, a second terminal 252, and a third terminal 253 are arranged on the front surface of the circuit board 250. A memory circuit 300, and two sensor connection terminals PT and NT are arranged on the back surface of the circuit board 250. The first terminal 251 is electrically connected to the first sensor connection terminal NT, and the second terminal 252 is electrically connected to the second sensor connection terminal PT. The third terminal 253 is electrically connected to the memory circuit 300. The memory circuit 300 includes a non-volatile storage device (described later) such as an EEPROM (Electrically Erasable and Programmable Read Only Memory) or the like.

We will return to FIG. 3 to give a description. The weld film 202 holds the sensor base member 210 in the opening of the base member holder 134, and tightly seals the base member holder 134 to form a liquid flow path. The weld film 202 is adhered to the outer peripheral edges of the surface on the Y axis forward direction side of the sensor base member 210, and is also welded to the weld rib 132. The cover 230 is arranged so as to press the sensor chip 220 and the weld film 202. The relay terminals 240 are housed in the cover 230. The relay terminals 240 include terminals 242 that are electrically connected to the electrodes of the piezoelectric element included in the sensor chip 220 via the hole 202a formed on the weld film 202. The circuit board 250 is mounted on the cover 230, and is electrically connected to the terminals 244 of the relay terminals 240.

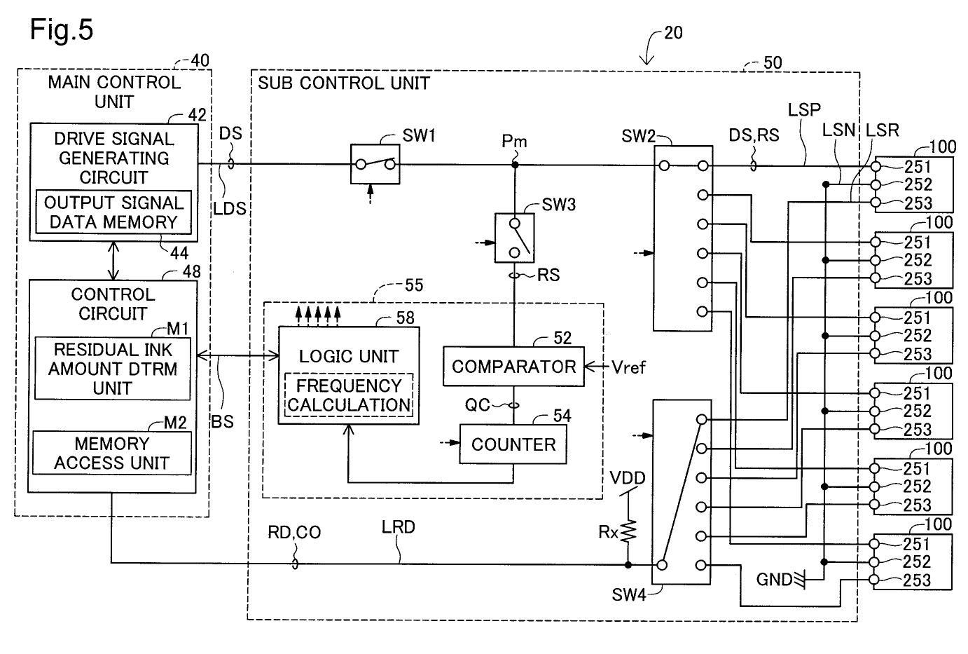

FIG. 5 is a first explanatory drawing showing the electrical constitution of the printer of the first embodiment. FIG. 5 is depicted with a focus on the parts necessary for processing related to the ink cartridge 100. The processing related to the ink cartridge 100 includes the process of determining the remaining amount of ink (hereafter called residual ink amount determination process) and the process of accessing the storage device of the memory circuit 300 (hereafter called the memory accessing process). The main control unit 40 is equipped with a drive signal generating circuit 42 and a first control circuit 48 that includes a CPU and a memory.

The drive signal generating circuit 42 is equipped with a drive signal data memory 44. Data indicating the drive signal DS is stored in the drive signal data memory 44. The drive signal DS includes a sensor drive signal DS1 for driving the piezoelectric element of the sensor chip 220, and a memory drive signal DS2 for accessing the storage device 340 of the memory circuit 300. The drive signal generating circuit 42 reads the data from the drive signal data memory 44 according to instructions from the first control circuit 48, and generates drive signals DS having a desired waveform.

Note that with this embodiment, the drive signal generating circuit 42 is further able to generate head driving signals supplied to the printing head 68. Specifically, with this embodiment, the first control circuit 48 generates the sensor drive signal DS1 and the memory drive signal DS2 at the drive signal generating circuit 42 when processing related to the ink cartridge 100 is executed, and generates head driving signals at the drive signal generating circuit 42 when executing printing by spraying ink.

The first control circuit 48 includes as functional units an residual ink amount determination unit M1 for executing residual ink amount determination processing, and a memory access unit M2 for executing memory access processing. Processing by these functional units is described below.

The sub control unit 50 is equipped with three types of switches SW1 to SW3, and a second control circuit 55. The second control circuit 55 is equipped with a comparator 52, a counter 54, and a logic unit 58. The logic unit 58 controls the operation of the switches SW1 to SW3 and the counter 54. Also, the logic unit 58 is able to perform communication with the first control circuit 48 via the bus BS. Note that with this embodiment, the logic unit 58 is constituted by one chip (ASIC).

The first switch SW1 is a 1-channel analog switch. One terminal of the first switch SW1 is connected to the drive signal generating circuit 42 of the main control unit 40 via the sensor drive signal line LDS. The other terminal of the switch SW1 is connected to the second and third switches SW2 and SW3. The first switch SW1 is set to be in the ON state when the sensor drive signal DS1 or the memory drive signal DS2, which are the drive signals DS related to the ink cartridge 100, is being supplied, and is set to be in an OFF state when the response signal RS from the piezoelectric element of the sensor chip 220 is being detected.

The second switch SW2 is a 6-channel analog switch. One terminal of one side of the second switch SW2 is connected to the first and third switches SW1 and SW3, and the respective six terminals of the other side are connected via wiring LSP to the first terminal 251 of the respective ink cartridges 100 when the ink cartridge 100 is mounted in the printer 20.

The third switch SW3 is a 1-channel analog switch. One terminal of the third switch SW3 is connected to the first and second switches SW1 and SW2, and the other terminal is connected to the comparator 52 of the second control circuit 55. The third switch SW3 is set to be in an OFF state when the drive signal DS (sensor drive signal DS1 or memory drive signal DS2) is being supplied to the first terminal 251 of the ink cartridge 100, and is set to be in an ON state when the response signal RS from the piezoelectric element of the sensor chip 220 is being detected.

The fourth switch SW4 is a 6-channel analog switch. One terminal of one side of the second switch SW2 is connected to the first control circuit 48 via a memory read signal line LRD, and the six terminals of the other side are connected to the respective third terminals 253 of the ink cartridges 100 via the wiring LSR when the ink cartridge 100 is mounted in the printer 20. Also, one terminal of one side of the fourth switch SW4 is connected to the power supply potential VDD (e.g. 3.3 V) via the pull-up resistor Rx.

The sub control unit 50 is wired such that the second terminal 252 of the ink cartridge 100 is grounded to the reference potential GND via the wiring LSN when the ink cartridge 100 is mounted in the printer 20.

The comparator 52 includes an operational amplifier, and with the residual ink amount determination process, it compares the response signal RS supplied via the third switch SW3 and the reference voltage Vref, and outputs a signal QC indicating the comparison result. In specific terms, the comparator 52 has the output signal QC at H level when the voltage of the response signal RS is equal to or higher than the reference voltage Vref, and has the output signal QC be L level when the voltage of the response signal RS is lower than the reference voltage Vref.

The counter 54 counts the number of pulses included in the output signal QC from the comparator 52 with the residual ink amount determination process, and gives the count value to the logic unit 58. Note that the counter 54 executes the counting operation in the period set to an enable state by the logic unit 58.

The logic unit 58 controls the second switch SW2 and the fourth switch SW4, and selects one ink cartridge 100 to be subject to residual ink amount determination processing or memory access processing. Then, the logic unit 58 has the first switch SW1 set to an ON state and the third switch SW3 set to an OFF state when the sensor drive signal DS1 or the memory drive signal DS2 is being supplied. Also, the logic unit 58 has the first switch SW1 set to an OFF state and the third switch SW3 set to an ON state when the response signal RS from the piezoelectric element of the sensor chip 220 is being detected.

Also, the logic unit 58 has the counter 54 set to an enable state during the period for which the response signal RS from the piezoelectric element of the sensor chip 220 is to be detected in the residual ink amount determination process. Then, using the count value of the counter 54, the logic unit 58 measures the time (measurement time) required until a specified number of pulses included in the output signal QC from the comparator 52 are generated. In specific terms, an oscillator (not illustrated) is provided inside the sub control unit 50, and using the clock signals output from the oscillator, the measurement time is measured. Then, based on the pulse count of the output signal QC counted by the counter and on the measurement time, the logic unit 58 calculates the frequency Hc of the response signal RS. Note that the frequency Hc of the response signal is equal to the frequency at which the piezoelectric element of the sensor chip 220 vibrates. The calculated frequency Hc is supplied to the first control circuit 48 of the main control unit 40.

The first control circuit 48 of the main control unit 40 determines whether or not the residual ink amount inside the selected ink cartridge 100 is a specified amount or greater based on the calculated frequency Hc in the residual ink amount determination process. In specific terms, when the calculated frequency Hc is approximately equal to the first oscillation count H1, the residual ink amount is determined to be equal to or more than the specified amount, and when it is approximately equal to the second vibration count H2, the residual ink amount is determined to be less than the specified amount. These vibration counts H1 and H2 may be experimentally set in advance as the characteristic vibration counts corresponding to the respective residual ink amounts.

As described above, the main control unit 40 and the sub control unit 50 work together to determine the residual ink amount of each ink cartridge. Note that the first control circuit 48 of the main control unit 40 supplies the determination results to a computer 90. As a result, the computer is able to notify the user of the residual ink amount determination results.

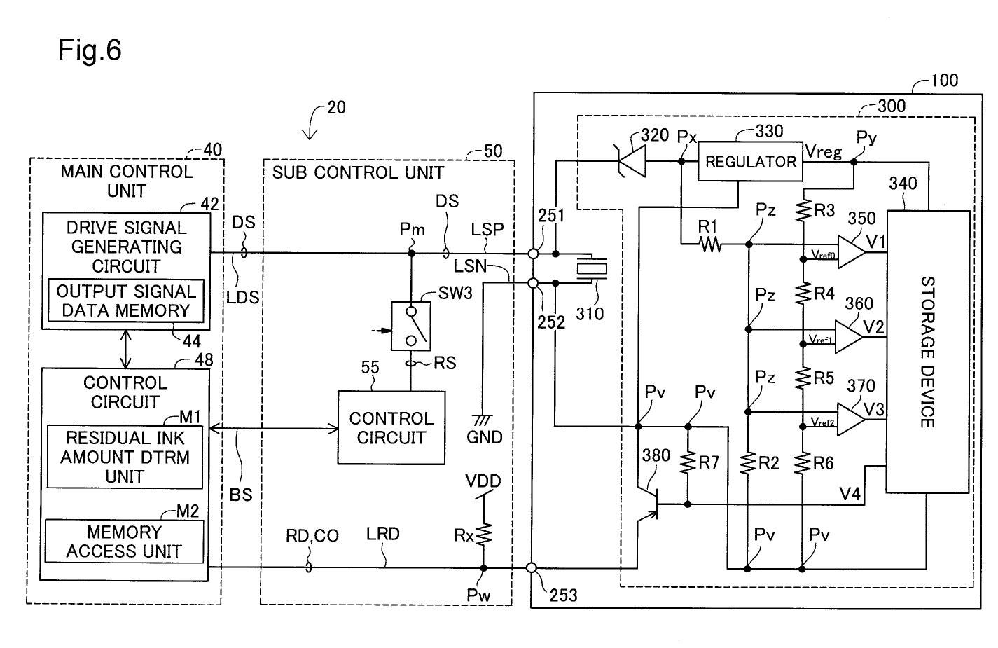

FIG. 6 is a second explanatory drawing showing the electrical configuration of the printer with the first embodiment. FIG. 6 is drawn with a focus on the electrical configuration of one ink cartridge 100. In FIG. 6, the constitution of the sub control unit 50 of the printer 20 shows the simplified form where one ink cartridge 100 is selected as the subject of the residual ink amount determination process or the memory access process. Specifically, in FIG. 6, the second switch SW2, the fourth switch SW4, and the other five ink cartridges 100 are omitted from the drawing. In reality, the other five ink cartridges 100 have the same constitution as the ink cartridge 100 shown in FIG. 6.

The ink cartridge 100 is equipped with a piezoelectric element 310 contained in the sensor chip 220 and the memory circuit 300 described above as the electrical configuration. Note that with this embodiment, the piezoelectric element 310 and the memory circuit 300 correlate to the electrical circuit in the claims. The memory circuit 300 includes a Zener diode 320, a regulator 330, a storage device 340, first to third comparators 350, 360, and 370, a PNP type bipolar transistor 380, and seven resistors R1 to R7. The Zener diode 320 breakdown voltage ZDV is approximately 20 V, for example. The regulator 330 converts the voltage input from an electrical node Px to a constant voltage Vreg and outputs it to another electrical node Py. The constant voltage Vreg is approximately 3.3 V, for example. Also, the reference potential GND is supplied to the regulator 330 via the second terminal 252. The storage device 340 is a non-volatile memory as described above. The constant voltage Vreg output from the regulator 330 is supplied to the storage device 340 as drive voltage (power supply). The comparators 350, 360, and 370 compare the first and second voltages supplied to the first and second input terminals. When the first voltage is larger than the second voltage, the comparators 350, 360, and 370 output high level (e.g. 3.3 V) signals, and when the first voltage is smaller than the second voltage, they output low level signals (e.g. 0 V). The output signals of the comparators 350, 360, and 370 are respectively referred to as output signals V1, V2, and V3. As with the case of the storage device 340, the constant voltage Vreg is supplied from the regulator 330 to the comparators 350, 360, and 370 as the drive voltage, although the connection is omitted from the drawing to avoid complexity.

We will describe the wiring of the electrical constitutional elements described above of the ink cartridge 100. One electrode of the piezoelectric element 310 is connected to the first terminal 251 of the circuit board 250 (FIG. 4A), and the other electrode is connected to the second terminal 252. The cathode electrode of the Zener diode 320 is connected to the first terminal 251 in parallel with the piezoelectric element 310. The anode electrode of the Zener diode 320 is connected to the electrical node Px. Specifically, the anode electrode of the Zener diode 320 is connected to the power supply input terminal of the regulator 330, and one electrode of the resistor R1. The constant voltage Vreg that is the output voltage of the regulator 330 is supplied to the storage device 340 as the drive voltage, and is also connected to one electrode of the resistor R3. The resistors R3, R4, R5, and R6 are connected in series between the electrical node Py to which the constant voltage Vreg is supplied, and another electrical node Pv to which the reference potential GND (e.g. 0 V) is supplied. The reference voltages Vref0, Vref1, and Vref2 which are constant voltages are generated by voltage division using these resistors R3, R4, R5, and R6. The generated reference voltage Vref0 is input to the first input terminal of the first comparator 350. Similarly, the generated reference voltage Vref1 is input to the first input terminal of the second comparator 360, and the reference voltage Vref2 is input to the first input terminal of the third comparator 370. The resistors R1 and R2 are connected in series between the electrical node Px connected to the anode electrode of the Zener diode 320 and the electrical node Pv to which the reference potential GND is supplied. As will be described later, when the memory drive signal DS2 is supplied to the first terminal 251, the electric potential of the electrical node Px is approximately 0 to 20 V. At this time, the voltage of the electrical node Pz between the resistors R1 and R2 is adjusted to approximately 0.4 to 3.3 V by voltage division using the resistors R1 and R2. One electrode of the resistor R7 is connected to the electrical node Pv to which the reference potential GND is supplied, and the other electrode is connected to the control electrode (base) of the bipolar transistor 380 and the storage device 340. The input electrode (emitter) of the bipolar transistor 380 is connected to third terminal 253. The control electrode (base) of the bipolar transistor 380 is further connected to the storage device 340. The output electrode (collector) of the bipolar transistor 380 is connected to the electrical node Pv to which the reference potential GND is supplied. The storage device 340 outputs the data signal V4 (high level or low level) according to the data stored in the storage device 340 to the base of the bipolar transistor 380. As will be described later, when the data signal V4 is low level, current flows between the emitter and collector of the bipolar transistor 380, and when the data signal V4 is high level, current does not flow between the emitter and collector of the bipolar transistor 380. Therefore, when the data signal V4 is low level, current flows between the emitter and collector of the bipolar transistor 380 and to the resistor R7, so the voltage of an electrical node Pw becomes low level. When the data signal V4 is high level, current does not flow between the emitter and collector of the bipolar transistor 380 and to the resistor R7, so the voltage of the electrical node Pw is high level (power supply electric potential level VDD). As a result, the main control unit 40 is able to detect the variation of the voltage of the electrical node Pw via the memory read signal line LRD, and is able to recognize the contents of the data signal V4 output by the storage device 340. Note that with this specification, for convenience of description, the electrical nodes Pm, Pv, Pw, Px, Py, and Pz are shown as points on a wire, but this does not mean that there are structural items corresponding to these electrical nodes on the actual circuit.

### Residual Ink Amount Determination Process

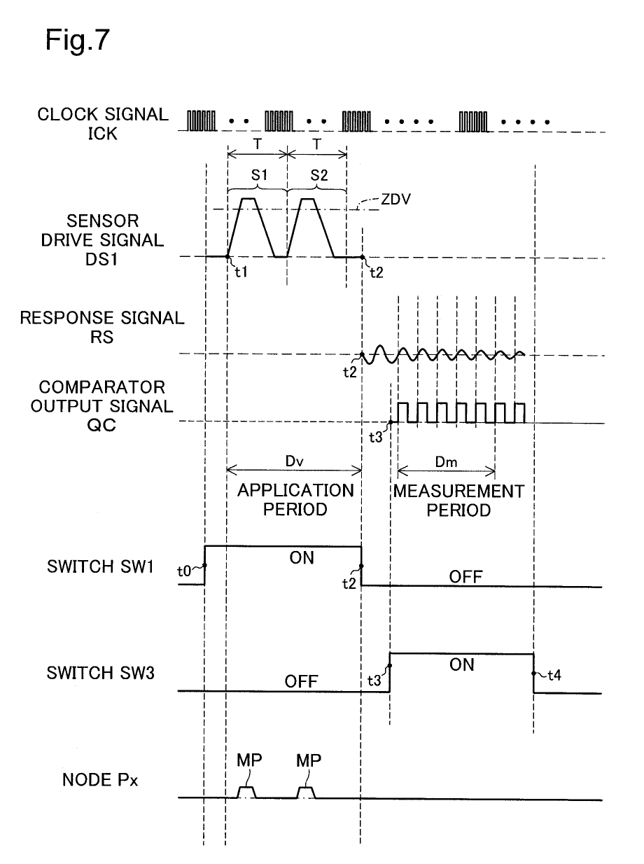

FIG. 7 is a timing chart of the residual ink amount determination process of the first embodiment. FIG. 7 shows the clock signal ICK, the sensor drive signal DS1, the response signal RS, the comparator output signal QC, and the voltage of the electrical node Px shown in FIGS. 5 and 6. The clock signal ICK is the output of an oscillator (not illustrated) inside the sub control unit 50. The sensor drive signal DSI and the response signal RS are signals that appear in the electrical node Pm shown in FIGS. 5 and 6. Furthermore, FIG. 7 shows the operation of the first switch SW1 and the third switch SW3.

The sub control unit 50 executes the residual ink amount determination process of the ink cartridge 100 according to instructions sent from the main control unit 40 via the bus BS. First, at time t0, the first switch SW1 is switched from the OFF state to the ON state, and also, the piezoelectric element 310 of one of the ink cartridges 100 is selected by the second switch SW2. Accordingly, the selected piezoelectric element 310 and the sub control unit 50 is able to exchange signals via the wiring LSP. Specifically, the sensor drive signal DS1 is applied to the piezoelectric element 310 from the sub control unit 50, and it is possible for the second control circuit 55 to receive the response signal RS from the piezoelectric element 310.

At times t1 and t2 (during application period Dv), the sensor drive signal DS1 is supplied to the piezoelectric element 310. Specifically, the voltage is applied to the piezoelectric element 310. Note that the third switch SW3 is set to the OFF state during the application period Dv.

As shown in the drawing, the sensor drive signal DS1 includes two pulse signals S1 and S2. The two pulse signals S1 and S2 are set to have the same cycle T. Note that the cycle T is set to a period (=1/H1) (e.g. approximately 33 μs) corresponding to the characteristic vibration count H1 of the piezoelectric element when the residual ink amount within the ink cartridge is equal to or more than the specified amount.

At time t2, the first switch SW1 is switched to the OFF state, and the supply of the sensor drive signal DS1 to the piezoelectric element 310 is ended. Then, from time t2 and thereafter, the piezoelectric element 310 vibrates with a vibration frequency depending on the residual ink amount, and the response signal RS is output from the sensor accordingly.

At time t3 after a slight time is elapsed from time t2, the third switch SW3 is switched to the ON state. At this time, the response signal RS from the piezoelectric element 310 is supplied to the comparator 52. The comparator 52 compares the response signal RS and the reference voltage Vref to output an H level or L level signal QC.

During the period starting from the time t3, the logic unit 58 of the sub control unit 50 sets the counter 54 to the enable state, and also measures the time (measurement period Dm) required for five pulses to be output from the comparator 52. In specific terms, the logic unit 58 counts the number of pulses of the clock signal ICK generated in the period DM when the five pulses are being counted by the counter 54, specifically, in the period DM from when the rising edge of the first pulse is input until the rising edge of the sixth pulse is input, to thereby measure the measurement period Dm. Note that when the counter 54 receives the rising edge of the sixth pulse, the logic unit 58 sets the counter 54 to the disable state. Then, the logic unit 58 calculates the frequency Hc (=5/Dm) of a first signal element contained in the response signal RS based on the measurement period Dm measured by the logic unit 58 and the pulse count (five) of the output signal QC counted by the counter 54. As described previously, the calculated frequency Hc shows the frequency of the vibrations of the piezoelectric element 310.

After that, the first control circuit 48 of the main control unit 40 receives the measured frequency Hc of the first signal element, and based on that frequency Hc, a determination is made of whether or not the residual ink amount is equal to or more than the specified amount. Note that at time t4 after the measurement period Dm has ended, the third switch SW3 returns from ON state to the OFF state.

Here, looking at the electric potential of the electrical node Px in the residual ink amount determination process, when the drive signal DS is supplied to the piezoelectric element 310 at the electrical node Px, an instantaneous voltage rise MP corresponding to the pulse signals S1 and S2 included in the senor drive signal DS1 is seen. However, the response signal RS and the majority of the sensor drive signal DS1 are not transmitted to the electrical node Px. This is because voltage smaller than the breakdown voltage ZDV of the Zener diode 320 is not transmitted by the Zener diode 320 to the storage device 340 side from the Zener diode 320. The storage device 340 is designed to not operate with an instantaneous voltage like the voltage rise MP. With this arrangement, it is possible to suppress faulty operation of the storage device 340 during the residual ink amount determination process. The Zener diode 320 of this embodiment correlates to the permission circuit of the claims.

### Memory Access Processing:

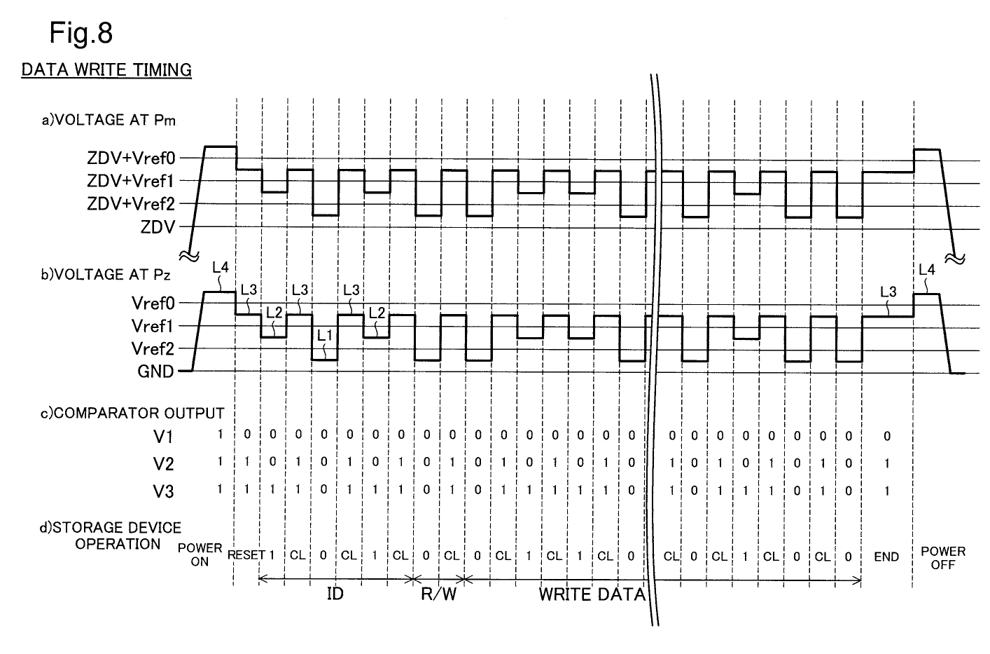

FIG. 8 is a timing chart of the memory access process when writing data to the storage device 340. FIG. 8 shows respectively in a) to d) the signals (voltage) at the electrical node Pm, the signal (voltage) at the electrical node Pz, the contents of the signals V1, V2, and V3 which are the output of the first to third comparators 350, 360, and 370, and the operation of the storage device 340 according to the input of the signals V1 to V3. The output signals V1, V2, and V3 of the first to third comparators 350, 360, and 370 are represented by “1” and “0” where “1” indicates high level, and “0” indicates low level.

When the memory access unit M2 of the first control circuit 48 accesses the storage device 340, similar to the residual ink amount determination process, the first control circuit 48 controls the second control circuit 55, switches the second switch SW2 and the fourth switch SW4, and selects the ink cartridge 100 to be subject to the access. Here, selection of the ink cartridge 100 with this embodiment means electrically connecting the wiring at which the electrical node Pm is positioned, and the wiring LSP connected to the first terminal 251 of the concerned ink cartridge 100 via the second switch SW2, and also electrically connecting the wiring LSR connected with the memory read signal line LRD, and the third terminal 253 of the concerned ink cartridge via the fourth switch SW4.

When the memory access unit M2 of the first control circuit 48 writes data to the storage device 340, the first control circuit 48 controls the drive signal generating circuit 42, and outputs the memory drive signal DS2 such as that shown in FIG. 8(a) on the electrical node Pm (=wiring LSP). The memory drive signal DS2 during data write is of a voltage larger than the breakdown voltage ZDV of the Zener diode 320 from start to end. The minimum voltage of the memory drive signal DS2 is greater than the breakdown voltage ZDV by a value equal to or more than the constant voltage Vreg which is the output voltage of the regulator 330. For example, when the constant voltage Vreg is 3.3 V with the breakdown voltage ZDV at 20 V, the minimum voltage of the memory drive signal DS2 is set to 23.3 V or greater. This is because the memory drive signal DS2 is also used as the drive power supply of the regulator 330. By working in this way, it is possible for the regulator 330 to supply a stable constant voltage Vreg to the storage device 340. To say this another way, while the memory drive signal DS2 is being output, the drive voltage is being output from the regulator 330 to the storage device 340 and the first to third comparators 350, 360, and 370. As a result, while the memory drive signal DS2 is being output, it is possible for the storage device 340 and the first to third comparators 350, 360, and 370 to operate. Note that the maximum voltage of the memory drive signal DS2 is approximately 40 V with this embodiment.

Of the voltage of the electrical node Pm (memory drive signal DS2), the voltage variation exceeding the breakdown voltage ZDV is converted by the Zener diode 320 and the resistors R1 and R2 to a voltage variation at the electrical node Pz, which takes a voltage value between the reference potential GND (e.g. 0 V) and the power supply voltage of the storage device 340 (with this embodiment, constant voltage Vreg=3.3 V). Of the voltage of the electrical node Pm (memory drive signal DS2), the voltage variation exceeding the breakdown voltage ZDV has four levels having approximately equal differences. The voltage of the electrical node Pz has four levels L1-L4 corresponding to the electrical node Pm voltage, and the first lowest level L1 is positioned between the reference potential GND and the reference voltage Vref2. Similarly, the second lowest level L2 of the four levels of the electrical node Pz voltage is positioned between the reference voltages Vref2 and Vref1, and the third lowest level L3 is positioned between the reference voltages Vref1 and Vref0. The highest or the fourth lowest level L4 of the four levels of the electrical node Pz voltage is larger than the reference voltage Vref0. As can be understood from the above description, the first control circuit 48 controls the voltage of the electrical node Pz at four levels L1-L4 between the reference potential GND and the constant voltage Vreg by controlling the voltage levels of the memory drive signal DS2 at four levels. As can be understood from FIGS. 6 and 8, when the electric potential Pz is at the first level L1, the output signals V1, V2, and V3 of the first to third comparators 350, 360, and 370 respectively represent 0, 0, and 0. Similarly, when the electrical node Pz is at the second level L2, the output signals V1, V2, and V3 respectively represent 0, 0, and 1, when the electrical node Pz is at the third level L3, the output signals V1, V2, V3 respectively represent 0, 1, and 1, and when the electrical node Pz is at the fourth level L4, the output signals V1, V2, and V3 respectively represent 1, 1, and 1. Therefore, the storage device 340 is able to recognize the four levels L1-L4 by receiving the output signals V1, V2, and V3.

When writing data to the storage device 340, the first control circuit 48 starts the output of the memory drive signal DS2, and the voltage of the electrical node Pz is maintained at the fourth level L4 for a specified time. With this arrangement, the supply of the constant voltage Vreg from the regulator 330 to the storage device 340 is started, and the power supply of the storage device 340 is put in the ON state.

Next, the first control circuit 48 maintains the voltage of the electrical node Pz at the third level L3 by controlling the voltage level of the memory drive signal DS2. Immediately after the power supply has turned to an ON state, when the storage device 340 recognizes the third level L3, it interprets this as being a reset signal, and recognizes the start of access to itself.

Subsequently, the first control circuit 48 sends the identification number (ID) of the ink cartridge 100 by a so-called self-clock type data sending method with which data signals and clock signals CL appear alternately. The data signal is the signal representing “1” or “0.” With this embodiment, the signal with the electrical node Pz maintained at the second level L2 represents data “1,” and the signal with the electrical node Pz maintained at the first level L1 represents data “0.” Meanwhile, the clock signal CL is represented by the signal for which the electrical node Pz is maintained at the third level L3. With the example shown in FIG. 8, as the data representing the identification number, we can see that data of the three bits “1, 0, 1” are sent to the storage device 340. When the received identification number and its own identification number match, the storage device 340 recognizes that itself is subject to access. Note that with this embodiment, one ink cartridge 100 is selected as the subject of access by the second switch SW2 and the fourth switch SW4, and the memory drive signal DS2 is sent only to the ink cartridge 100 subject to access. Therefore, it is also possible to omit the sending of the identification number, and it is possible to have the ink cartridge 100 recognize that the received signals are all signals subject to access of itself.

Following the sending of the identification number, the first control circuit 48 sends a 1-bit read/write identification signal (R/W signal) using the same self-clock type data sending method as for sending the identification number. The “0” R/W signal shows that the concerned access is access for data write. The “1” R/W signal shows that the concerned access is access for data read. The example in FIG. 8 illustrates data write, so the R/W signal is “0.” When the R/W signal “0” is received, the storage device 340 subsequently writes the sent data in sequence to its own memory.

Following sending of the R/W signal, the first control circuit 48 sends the write data using the same self-clock type data sending method. When sending of the write data ends, the first control circuit 48 maintains the electrical node Pz voltage at the third level L3 across a specified period longer than the one time clock signal sending time, and subsequently, maintains the electrical node Pz voltage at the fourth level L4 for a specified time. When the storage device 340 receives this kind of signal, the storage device 340 recognizes the end of the access. After that, to end the supplying of the memory drive signal DS2, the regulator 330 stops that operation. Therefore, the supplying of the constant voltage Vreg to the storage device 340 is stopped, and the storage device 340 power supply goes to the OFF state.

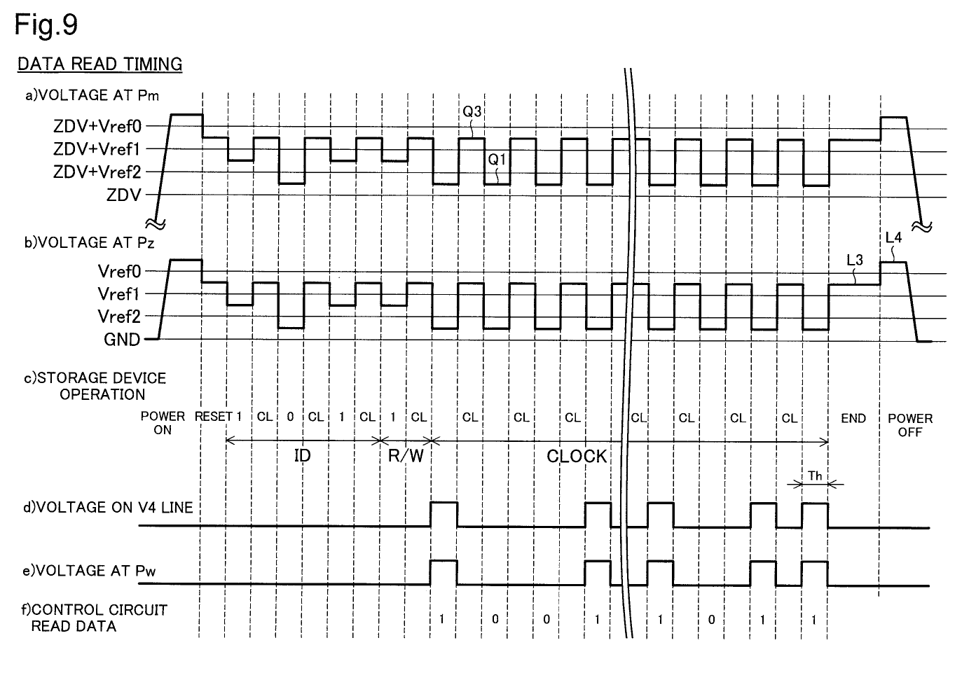

FIG. 9 is a timing chart of the memory access process when reading data from the storage device 340. In FIG. 9, the signal at the electrical node Pm, the signal at the electrical node Pz, the operation of the storage device 340 using the first to third comparator 350, 360, and 370 output signals V1, V2, and V3, the data signal V4 output by the storage device 340, the signal at the electrical node Pw, and the contents of the data recognized by the first control circuit 48 based on the electrical node Pw (read data) are respectively indicated in a) to f). The data signal V4 output by the storage device 340 is a signal represented on the wire connecting the storage device 340 and the bipolar transistor 380 control electrode (gate electrode) (FIG. 6).

The process of the first control circuit 48 reading data from the storage device 340 of the ink cartridge 100 subject to access is the same as the process of writing data to the storage device 340 described above until sending of the identification signal (ID), so that description is omitted.

Following the sending of the identification number, the first control circuit 48 sends a 1-bit read/write identification signal (R/W signal) using the same self-clock type data sending method as when sending the identification number. With the reading process, the sent R/W signal is “1.” When the R/W signal is sent, the first control circuit 48 subsequently sends the clock to the storage device 340. The clock is a signal that repeats the third level voltage Q3 representing the clock signal CL (high level signal) and the first level voltage Q1 (low level signal). When the R/W signal “1” is received, the storage device 340 reads data stored in its own memory, synchronizes with the sent clock, and outputs the read data as data signal V4. Specifically, the storage device 340 outputs a high level or low level data signal V4 during the period between one clock signal CL and the next clock signal CL. The high level data signal V4 shows “1,” and the low level data signal V4 shows “0.” The storage device 340 maintains the data signal V4 at low level during the period the clock signal CL is being received.

When the high level data signal V4 is output, as described above, the potential of the electrical node Pw becomes the high level. The first control circuit 48 detects this kind of variation in the potential of the electrical node Pw as a read signal RD via the signal line LRD. Detection of the read signal RD is performed in synchronism with the clock that the first control circuit 48 outputs itself. By doing as noted above, the first control circuit 48 is able to read data from the storage device 340.

When data read ends by detection of the read signal RD, the first control circuit 48 maintains the voltage of the electrical node Pz at the third level L3 across a specified period that is longer than the one time clock signal sending time, and subsequently, maintains the voltage of the electrical node Pz at the fourth level L4 across a specified time. When the storage device 340 receives this kind of signal, the storage device 340 recognizes the end of accessing. After that, to end supplying of the memory drive signal DS2, the regulator 330 stops the operation. Therefore, the supply of the constant voltage Vreg to the storage device 340 is stopped, and the storage device 340 is in a state with the power supply off.

### Ink Cartridge Mounting Detection:

The first control circuit 48 is also able to determine for each ink cartridge attachment position whether or not the ink cartridge 100 is mounted on or removed from the carriage 30 by detecting the electric potential of the electrical node Pw (the electric potential of the memory read signal line LRD).

In specific terms, when the ink cartridge 100 is mounted at a specified ink cartridge attachment position, the third terminal 253 of the ink cartridge 100 is electrically connected to the memory read signal line LRD. The storage device 340 of the ink cartridge 100 supplies low level signals (e.g. the reference potential GND) to the base of the bipolar transistor 380 except when sending memory data to the first control circuit 48 (FIG. 9). Specifically, normally, the electric potential of the third terminal 253 of the ink cartridge 100 is maintained at low level. Therefore, when the ink cartridge 100 is mounted at a specified ink cartridge attachment position, normally, the electric potential of the memory read signal line LRD is maintained at low level via the third terminal 253 of the ink cartridge 100.

In contrast to this, when the ink cartridge 100 is not mounted at a specified ink cartridge attachment position, the voltage of the memory read signal line LRD is at high level. This is because the memory read signal line LRD is connected at a high level (power supply potential level VDD) via the pull-up resistor Rx (FIGS. 5, 6).

As can be understood from the description above, the first control circuit 48 is able to determine that the ink cartridge 100 is mounted at a corresponding ink cartridge attachment position when the voltage of the memory read signal line LRD is at low level. Meanwhile, the first control circuit 48 is able to determine that the ink cartridge 100 is not mounted at the corresponding ink cartridge attachment position when the voltage of the memory read signal line LRD is at high level across a specified period or greater. Here, the specified period is preferably a time for which the memory read signal line LRD is maintained at high level when reading data from the storage device 340, specifically, sufficiently longer than the period Th between one clock signal CL and the next clock signal CL shown in FIG. 9. By working in this way, the first control circuit 48 is able to suppress faulty determination regarding whether or not the ink cartridge 100 is mounted.

With the first embodiment described above, using the drive signal DS1 which represents a terminal potential difference between the first terminal 251 to which the printer 20 inputs a first potential, and the second terminal 252 to which the printer 20 inputs a second potential, it is possible for the printer 20 to exchange the signals (the sensor drive signal DS1 and the response signal RS) with the sensor including the piezoelectric element 310. Furthermore, using the memory drive signal DS2 which is the potential difference between these concerned terminals, it is possible to execute writing of data to the storage device 340. Also, using the memory drive signal DS2 which is the terminal potential difference between the first terminal 251 and the second terminal 252, and another terminal potential difference between the second terminal 252 and the third terminal 253, it is possible to execute reading of data from the storage device 340. The communication with the sensor and the communication with the storage device 340 can be executed separately. As a result, using only the three terminals 251, 252, and 253, communication with the piezoelectric element 310 and communication with the storage device 340 are performed, so it is possible to reduce the number of terminals with which the ink cartridge 100 is equipped. Therefore, it is possible to suppress the number of parts and also to do stable communication by reliable contact between the terminals.

Furthermore, by having the Zener diode 320 provided, the drive signal DS which is smaller than the breakdown voltage ZDV of the Zener diode 320 is not transmitted to the storage device 340 side, so it is possible to suppress faulty operation by the storage device 340 due to the residual ink amount determination process.

Furthermore, the sensor drive signal DS1 and the response signal RS used during the residual ink amount determination process are mostly signals of a voltage smaller than the breakdown voltage ZDV of the Zener diode 320, and the memory drive signal DS2 used for the memory access process is a signal of a voltage larger than the breakdown voltage ZDV of the Zener diode 320. Specifically, with the residual ink amount determination process and the memory access process, the range of the magnitude of the used voltage (terminal potential difference) is made to be different. As a result, it is possible to suppress faulty operation.

Furthermore, with the memory access process, the drive voltage (constant voltage Vreg) of the storage device 340 is supplied from the regulator 330, and the regulator 330 receives power supply from the memory drive signal DS2. Therefore, the power supply of the storage device 340 and the first to third comparators 350, 360, and 370 are also supplied from the printer 20 via the two terminals 251 and 252. Therefore, with few terminals, in addition to being able to communicate with both the piezoelectric element 310 and the storage device 340, it is also possible to supply power by which the storage device 340 operates. In this case, as long as it is a case of accessing the storage device 340, power is supplied to the storage device 340, so it is possible to suppress power consumption.

Furthermore, as described above, based on the terminal potential difference between the first terminal 251 and the third terminal 253, the printer 20 is able to determine whether or not the ink cartridge 100 is mounted. Therefore, with few terminals, in addition to being able to communicate with both the piezoelectric element 310 and the storage device 340, it is also possible to detect whether or not the ink cartridge 100 is mounted.

### B. Second Embodiment

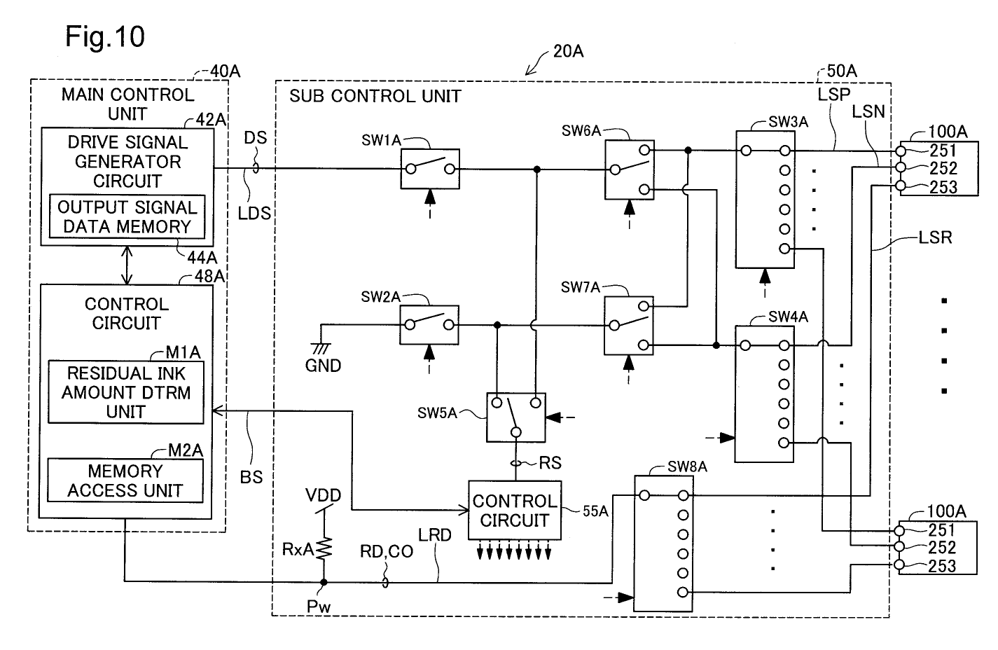

FIG. 10 is a first explanatory drawing showing the electrical configuration of the printer of the second embodiment. FIG. 10 is drawn with a focus on the parts necessary for processes related to the ink cartridge 100A of the second embodiment. For the constitution of the main control unit 40A in FIG. 10, for the same constitution as the main control unit 40 described while referring to FIG. 5, reference numerals have been given with an “A” added to the end of the reference numerals in FIG. 5.

The sub control unit 50A of the second embodiment is equipped with eight switches SW1A to SW8A. The switches SW4A to SW8A of these seven switches operate by the control of the second control circuit 55A similar to the switches SW1 to SW3 of the first embodiment.

The first switch SW1A is a 1-channel analog switch. One terminal of the first switch SW1A is connected to the drive signal generating circuit 42A of the main control unit 40, and the other terminal is connected to the sixth switch SW6A and the fifth switch SW5A.

The second switch SW2A is a 1-channel analog switch. One terminal of the second switch SW2A is connected to the reference potential GND, specifically, it is grounded. The other terminal of the second switch SW2A is connected to the seventh switch SW7A and the fifth switch SW5A.

The third switch SW3A is a 6-channel analog switch. One terminal of one side of the third switch SW3A is connected to one terminal of one side of the sixth switch SW6A and one terminal of one side of the seventh switch SW7A, and the six terminals of the other side are respectively connected via the first terminals 251 to the six ink cartridges 10A.

The fourth switch SW4A is a 6-channel analog switch. One terminal of one side of the fourth switch SW4A is connected to one terminal of one side of the sixth switch SW6A and to one terminal of one side of the seventh switch SW7A, and the six terminals of the other side are respectively connected via the second terminals 252 to the six ink cartridges 100A.

The fifth switch SW5A is a 2-channel analog switch. One terminal of one side of the fifth switch SW5A is connected to the second control circuit 55A. Of the two terminals on the other side of the fifth switch SW5A, one is connected to the terminal on the other side of the second switch SW2A and the seventh switch SW7A, and the other is connected to the terminal of the other side of the first switch SW1A and the sixth switch SW6A.

The sixth switch SW6A is a 2-channel analog switch. One terminal of one side of the sixth switch SW6A is connected to the first switch SW1A and the fifth switch SW5A as described above. Of the two terminals of one side of the sixth switch SW6A, one is connected to the third switch SW3A as described above, and the other is connected to the fourth switch SW4A.

The seventh switch SW7A is a 2-channel analog switch. One terminal of the other side of the seventh switch SW7A is connected to the second switch SW2A and the fifth switch SW5A as described above. Of the two terminals of one side of the seventh switch SW7A, one is connected to the third switch SW3A as described above, and the other is connected to the fourth switch SW4A.

The eighth switch SW8A is a 6-channel analog switch. One terminal of one side of the eighth switch SW8A is connected to the first control circuit 48 via the memory read signal line LRD, and the respective six terminals of the other side are connected to the respective third terminals 253 of the ink cartridges 100A via the wiring LSR when the ink cartridge 100A is mounted on the printer 20. Also, one terminal of one side of the fourth switch SW4 is connected to the power supply electric potential VDD (e.g. 3.3 V) via the pull-up resistor RxA.

When doing the residual ink amount determination process and the memory access process for one of the six ink cartridges 100A, the second control circuit 55A controls the third switch SW3A and the fourth switch SW4A so that the first and second terminals 251 and 252 of the cartridge subject to processing are electrically connected to the sixth and seventh switches SW6A and SW7A. Also, when doing memory access processing for one of the six ink cartridges 100A, the second control circuit 55A controls the eighth switch SW8A so that the third terminal 253 of the cartridge subject to processing is electrically connected to the first control circuit 48.

With the second embodiment, it is possible for the sensor drive signal DS1 to be supplied to the ink cartridge 100A from either of the first and second terminals 251 and 252, and also, for the response signal RS from the ink cartridge 100A to be received from either of the first and second terminals 251 and 252.

For example, with the residual ink amount determination process, when the sensor drive signal DS1 is to be supplied from the first terminal 251 of the subject cartridge and the response signal RS is to be received from the second terminal 252, the second control circuit 55A controls the sixth switch SW6A and the seventh switch SW7A to electrically connect the third switch SW3A and the first switch SW1A, and to electrically connect the fourth switch SW4A and the second switch SW2A. Also, the second control circuit 55A controls the fifth switch SW5A to electrically connect the second control circuit 55A and the seventh switch SW7A. The first switch SW1A and the second switch SW2A are set to an ON state (conductive state) when the sensor drive signal DS1 is being supplied to the ink cartridge 100A, and then the second switch SW2A is set to an OFF state (non-conductive state) when the response signal RS is being received.

On the hand, with the residual ink amount determination process, when the sensor drive signal DS1 is to be supplied from the second terminal 252 of the subject cartridge and the response signal RS is to be received from the same second terminal 252 of that cartridge, the second control circuit 55A controls the sixth switch SW6A and the seventh switch SW7A to electrically connect the fourth switch SW4A and the first switch SW1A and to electrically connect the third switch SW3A and the second switch SW2A. The first switch SW1A and the second switch SW2A are set to an ON state (conductive state) when the sensor drive signal DS1 is being supplied to the ink cartridge 100A; and then, when the response signal RS is being received, the first switch SW1A is set to an OFF state (non-conductive state), and the fifth switch SW5A is controlled to electrically connect the second control circuit 55A and the sixth switch SW6A.

In this way, with the residual ink amount determination process of the second embodiment, it is possible to selectively use either of the first pattern that supplies the sensor drive signal DS1 via the first terminal 251 with the second terminal 252 being set at the reference potential GND, and the second pattern that supplies the sensor drive signal DS1 via the second terminal 252 with the first terminal 251 being set at the reference potential GND.

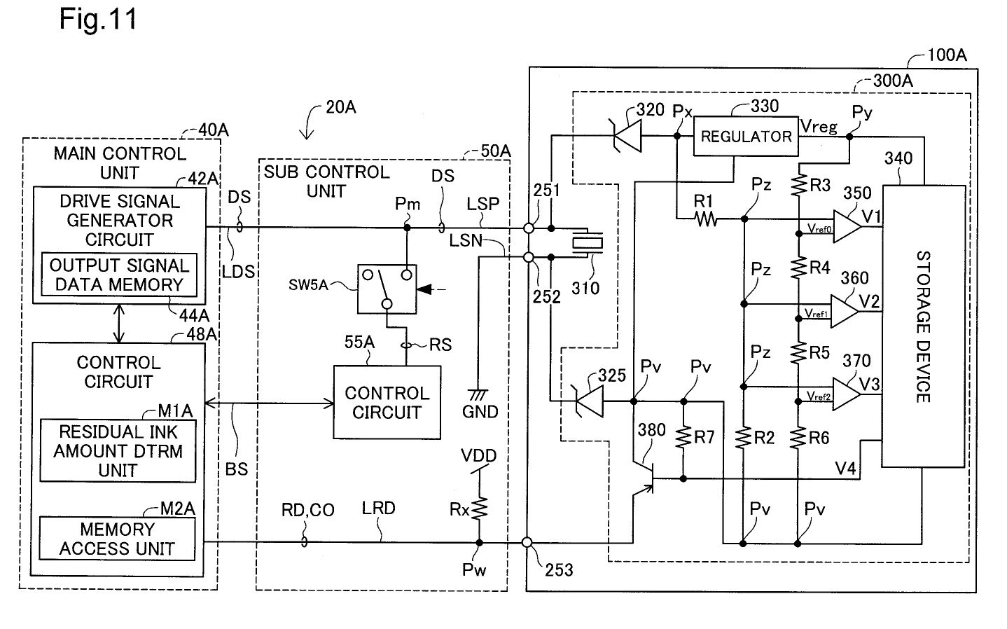

FIG. 11 is a second explanatory drawing showing the electrical configuration of the printer of the second embodiment. FIG. 11 is drawn with the focus on the electrical configuration of one ink cartridge 100A. FIG. 11 shows the simplified state of the sub control unit 50A of the printer 20A where one ink cartridge 100A is selected as the subject of the residual ink amount determination process with the sensor drive signal DS1 being supplied from the first terminal 251, or the state where the ink cartridge 100A is selected as the subject of the memory access process. Specifically, in FIG. 11, the switches other than the fifth switch SW5A and the other five ink cartridges are omitted from the illustration. Actually, the other five ink cartridges have the same constitution as the ink cartridge 100A shown in FIG. 11.

In addition to the Zener diode 320 of the first embodiment, the ink cartridge 100A has one more Zener diode 325. The cathode of the one more Zener diode 325 is connected with the second terminal 252, and the Zener diode 325 is connected to the electrical node Pv. The remainder of the constitution of the ink cartridge 100A is the same as the ink cartridge 100 of the first embodiment shown in FIG. 6, so in FIG. 11, the same reference numerals are given to the same constitutional elements and their description is omitted.

With the second embodiment described above, the same operation and effect occur as with the first embodiment. Furthermore, with the residual ink amount determination process of the second embodiment, there are available a first pattern that supplies the sensor drive signal DS1 via the first terminal 251 while the second terminal 252 is supplied with the reference potential GND, and a second pattern that supplies the sensor drive signal DS1 via the second terminal 252 while the first terminal 251 is supplied with the reference potential GND. Accordingly, the voltage of the second terminal 252 may be higher than the voltage of the first terminal 251, or the voltage of the first terminal 251 may be higher than the voltage of the second terminal 252. In these cases as well, by the ink cartridge 100A being equipped with a Zener diode 325, the electrical node Pv is maintained at a voltage close to the reference potential GND. As a result, it is possible to suppress faulty operation of the storage device 340 or the regulator 330.

### C. Third Embodiment

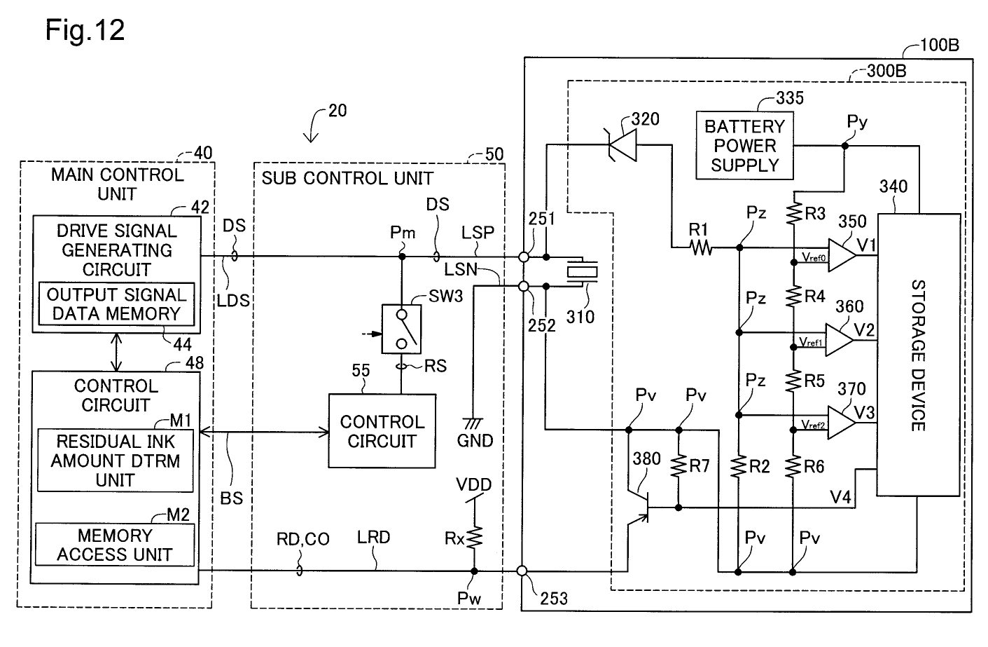

FIG. 12 is an explanatory drawing showing the electrical configuration of the printer of the third embodiment. FIG. 12 is drawn with a focus on the electrical configuration of one ink cartridge 100B. In FIG. 12, the constitution of the sub control unit 50 of the printer 20 is shown with the state of one ink cartridge 100B being selected as the subject of the residual ink amount determination process or the memory access process in simplified form. Specifically, in FIG. 12, the second switch SW2 and the other five ink cartridges are omitted from the drawing. In reality, the other five ink cartridges have the same constitution as the ink cartridge 100B shown in FIG. 12.

The constitution of the printer 20 (main control unit 40 and sub control unit 50) of the third embodiment is the same constitution as the printer 20 of the first embodiment, so the description of this is omitted. The ink cartridge 100B of the third embodiment is equipped with a battery power supply 335 instead of the regulator 330 of the first embodiment. For the battery power supply 335, it is possible to use various known batteries such as a manganese battery, an alkaline battery, a lithium battery, and a fuel cell.

With the third embodiment, the memory drive signal DS2 is not used as the power supply of the storage device 340, and the storage device 340 and the first to third comparators 350, 360, and 370 have the operating power supply from the battery power supply 330. Also, the reference voltages Vref0, Vref1, and Vref2 respectively supplied to the first to third comparators 350, 360, and 370 are created by voltage division by the resistors R3 to R6 of the constant voltage supplied by the battery power supply 335.

As can be understood from the description above, it is not necessary to supply the drive power supply of the storage device 340 from the printer 20 side, and it is possible to equip a power supply such as a battery or the like on the storage device 340.

### D. Fourth Embodiment

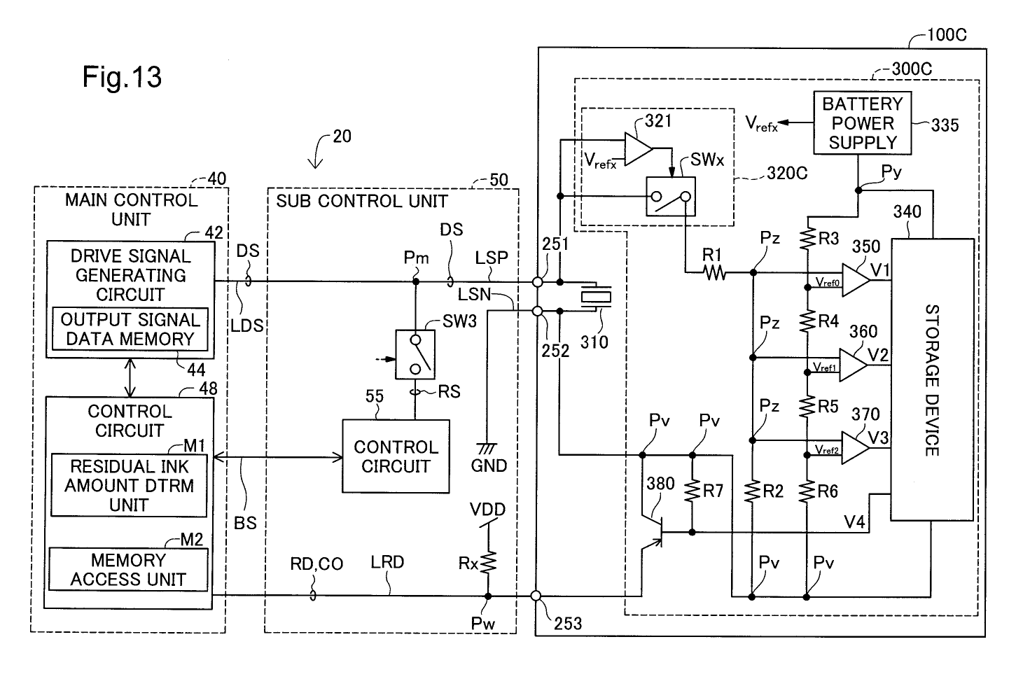

FIG. 13 is an explanatory drawing showing the electrical configuration of the printer of the fourth embodiment. FIG. 13 is drawn with a focus on the electrical configuration of one ink cartridge 100C. In FIG. 13, the constitution of the sub control unit 50 of the printer 20 is shown with the state of one ink cartridge 100C selected as the subject of the residual ink amount determination process or the memory access process in a simplified form. Specifically, in FIG. 13, the second switch SW2 and the other five ink cartridges are omitted from the drawing. In reality, the other five ink cartridges have the same constitution as the ink cartridge 100C shown in FIG. 13.

The constitution of the printer 20 (main control unit 40 and sub control unit 50) of the fourth embodiment is the same as the constitution of the printer 20 of the first embodiment, so the description is omitted.

The ink cartridge 100C of the fourth embodiment is equipped with a permission circuit 320C including a comparator 321 and an analog switch SWx, instead of the Zener diode 320 of the first embodiment. The comparator 321 sets the analog switch SWx to the ON state (conductive state) when the voltage of the first terminal 251 is larger than the permitted lower limit voltage Vrefx, and sets the analog switch SWx to the OFF state (non-conductive state) when the voltage of the first terminal 251 is smaller than the permitted lower limit voltage Vrefx. Here, the permitted lower limit voltage Vrefx is set to a value slightly smaller than the minimum level of the memory drive signal DS2 (corresponding to the first level of the electrical node Pz). In specific terms, the permitted lower limit voltage Vrefx is set to be almost the same as the breakdown voltage ZDV of the Zener diode 320 of the first embodiment.

The ink cartridge 100C of the fourth embodiment, as with the case of the third embodiment, is equipped with a battery power supply 335 instead of the regulator 330 of the first embodiment. The drive voltage of the storage device 340 and the first to third comparators 350, 360, and 370 is supplied from the battery power supply 335. The battery power supply 335 also outputs the permitted lower limit voltage Vrefx input as the reference voltage to the comparator 321 described above.

With the fourth embodiment described above, by having a permission circuit 320C provided, drive signals DS2 smaller than the permitted lower limit voltage Vrefx are not transmitted to the storage device 340 side, so the same as with the first embodiment, it is possible to suppress faulty operation by the storage device 340 due to the residual ink amount determination process.

### E. MODIFIED EXAMPLES

### First Modified Example

With the embodiments noted above, the electrical device driven by the sensor drive signal DS1 is realized by the piezoelectric element 310 which is an oscillation circuit that functions as a sensor, but instead of this, it is also possible to use an oscillation circuit that outputs a response signal RS indicating existence of ink in the ink cartridge regardless of the actual residual ink amount in the ink cartridge. This kind of oscillation circuit can be constituted using an LC oscillation circuit including a coil and capacitor, an RC oscillation circuit including a capacitor and resistor, or a solid state vibrator oscillation circuit including a crystal or ceramic vibrator, for example. Such an oscillation circuit, which outputs a response signal RS indicating existence of ink in the ink cartridge regardless of the actual residual ink amount in the ink cartridge, may be disposed on the circuit board 250 including the memory 300.

### Second Modified Example

With the embodiments noted above, the end of ink is detected based on the frequency of the response signal RS from the piezoelectric element 310, but it is also possible to use a sensor of another type that detects the end of ink based on the amplitude of the response signal. Also, this is not limited to being an ink end sensor, and it is also possible to use a sensor for detecting an ink temperature, resistance, or other characteristics of ink. Generally, any electrical device driven by a drive signal DS, which is not limited to sensors, may be used.

### Third Modified Example

With the embodiments noted above, the storage device 340 including memory is used as the electrical device driven by the memory drive signal DS2, but instead of this, it is also possible to use a central processing unit (CPU), various logic circuits, ASIC (Application Specific Integrated Circuit), or FPGA (Field Programmable Gate Array). Generally, it is acceptable as long as it is an electrical device driven by a drive signal DS.

### Fourth Modified Example

With the embodiments noted above, one ink tank is constituted as one ink cartridge 100, but it is also possible to constitute one ink cartridge 100 with a plurality of ink tanks.

### Fifth Modified Example

With the embodiments noted above, both writing and reading in relation to the storage device 340 are performed using the memory drive signal DS2, but instead of this, it is also possible to perform only one of write or read in relation to the storage device 340.

### Sixth Modified Example

With the embodiments noted above, the inkjet type printer 20 and the ink cartridges 100 are used, but it is also possible to use a liquid jetting apparatus that jets or sprays a liquid other than ink, and a liquid container that stores that liquid. What is called liquid here includes fluids for which functional material particles are dispersed in a medium, or a gel type fluid or the like. For example, it can also be a liquid jetting apparatus that jets a liquid including in a dispersed or dissolved form a material such as an electrode material or coloring agent used for manufacturing a liquid crystal display, an EL (electro luminescence) display, a surface emitting display, a color filter, or the like, a liquid jetting apparatus that jets a biological organic substance used for biochip manufacturing, or a liquid jetting apparatus used as a precision pipette for jetting a liquid that becomes a sample. Furthermore, it is also possible to use a liquid jetting apparatus for jetting lubrication oil with a pinpoint at a precision machine such as a clock or camera or the like, a liquid jetting apparatus for jetting on a substrate a transparent resin liquid such as an ultraviolet ray hardening resin or the like to form a micro hemispheric lens (optical lens) used for optical communication components or the like, or a liquid jetting apparatus for jetting an etching fluid such as acid or alkali or the like to etch a substrate or the like. Then, it is possible to apply the present invention to any one type of these jetting devices, and the liquid container for that liquid.

### Seventh Modified Example

With the embodiments and modified examples noted above, the circuit board 250 including the memory circuit 300 is mounted on the ink cartridge which is the ink container in which ink is stored, but it is also possible to use completely physically separated individual units as the ink container and the circuit board 250. For example, it is also possible to attach a plate having the circuit board 250 on the printing head unit 60, using a specified attachment fitting on the printing head unit 60 to thereby electrically connect the circuit board 250 to the sub control unit 50, while on the other hand an ink container placed at a separate location is connected to the ink take up needle of the printing head unit 60 via a flexible tube. Generally, any ink supplying device, which is not limited to an ink container, may be used to supply ink to a printer.

### Eighth Modified Example

It is possible to replace part of the constitution that was realized using hardware with the embodiments noted above by using software, and conversely, it is possible to replace part of the constitution that was realized using software by using hardware. For example, the residual ink amount determination unit M1 and the memory access unit M2 of the main control unit 40 can be realized using software or can be realized using hardware.

Embodiments and modified examples of the present invention have been described above, but the present invention is not limited to these embodiments and modified examples, and it is possible to implement it in various modes within a scope that does not stray from the spirit of the invention.

What is claimed is:

1. A liquid container mountable on a liquid jetting apparatus, comprising:
an electrical circuit including a first electrical device and a second electrical device;
a first terminal;
a second terminal; and
a third terminal,
the electrical circuit being constituted such that the liquid jetting apparatus is able:
to execute sending of signals to the first electrical device and sending of signals to the second electrical device using a terminal potential difference which is a difference between electric potential inputs to the first and second terminals,
to selectively execute either one of the sending of signals to the first electrical device and the sending of signals to the second electrical device by using different magnitudes of the terminal potential difference, and
to execute receiving of signals from the first electrical device via the third terminal.

2. The liquid container according to claim 1, wherein
the electrical circuit is further constituted such that the liquid jetting apparatus is able to supply drive power to the first electrical device via the first terminal.

3. The liquid container according to claim 1, wherein
the electrical circuit further includes a permission circuit that permits a variation in the terminal potential difference to be supplied to the first electrical device if the terminal potential difference exceeds a threshold value.

4. The liquid container according to claim 1, wherein
the permission circuit includes a Zener diode.

5. The liquid container according to claim 1, wherein
the electrical circuit is further constituted such that the liquid jetting apparatus is able to detect whether or not the liquid container is mounted on the liquid jetting apparatus via the third terminal.

6. The liquid container according to claim 1, wherein
the first electrical device further includes a memory,
the sending of signals to the first electrical device includes sending of signals for at least one of writing to the memory or reading from the memory, and
a magnitude of the terminal potential difference for the sending of signals to the first electrical device is greater than a magnitude of the terminal potential difference for the sending of signals to the second electrical device.

7. The liquid container according to claim 1, wherein
the second electrical device includes an oscillation circuit,
communication between the ink jetting apparatus and the second electrical device includes sending of a drive signal to the oscillation circuit from the liquid jetting apparatus, and receiving of a response signal from the oscillation circuit by the liquid jetting apparatus, and
a magnitude of the terminal potential difference for the sending of signals to the second electrical device is smaller than a magnitude of the terminal potential difference for the sending of signals to the first electrical device.

8. The liquid container according to claim 1, wherein
the first electrical device includes a memory,
the sending of signals to the first electrical device includes sending of signals for at least one of writing to the memory and reading from the memory,
the second electrical device includes an oscillation circuit, and
communication between the ink jetting apparatus and the second electrical device includes sending of a drive signal to the oscillation circuit from the liquid jetting apparatus, and receiving of a response signal from the oscillation circuit by the liquid jetting apparatus.

9. The liquid container according to claim 8, wherein
a magnitude of the terminal potential difference for the sending of signals to the memory is larger than a magnitude of the terminal potential difference for the sending of signals the oscillation circuit.

10. The liquid container according to claim 8, wherein
the electrical circuit further includes a regulator that is connected to the first terminal in parallel with the oscillation circuit, and that converts a voltage input to the first terminal into a drive power supply for the memory and supplies the same to the memory.

11. The liquid container according to claim 10, wherein
the electrical circuit further includes a Zener diode disposed between the first terminal and the regulator.

12. The liquid container according to claim 8, wherein
the electrical circuit further includes:
a plurality of comparators whose outputs are supplied to the memory; and
wiring connected to the first terminal in parallel to the oscillation circuit, and connected to a respective one of input terminals of the plurality of comparators.

13. The liquid container according to claim 12, wherein
the electrical circuit further includes a Zener diode disposed between the first terminal and the respective one of input terminals of the plurality of comparators.

14. The liquid container according to claim 8, wherein
the electrical circuit further includes:
a regulator that is connected to the first terminal in parallel with the oscillation circuit, and that converts a voltage input to the first terminal into a drive power supply for the memory and supplies the same to the memory,
a plurality of comparators whose outputs are supplied to the memory; and
wiring connected to the first terminal in parallel to the oscillation circuit, and connected to a respective one of input terminals of the plurality of comparators; and
a voltage divider circuit that divides a voltage of the drive power supply supplied by the regulator, and inputs the divided voltages to a respective another one of input terminals of the plurality of comparators.

15. The liquid container according to claim 8, wherein
the electrical circuit further includes a transistor having a control electrode to which an output from the memory is input, and
the electrical circuit is constituted such that a voltage of the third terminal varies depending on whether the transistor is in an ON state or an OFF state, and the liquid jetting apparatus is able to execute reading from the memory based on detection of variation of the voltage of the third terminal.

16. The liquid container according to claim 8, wherein
the electrical circuit further includes a Zener diode disposed between the second terminal and the memory.

17. The liquid container according to claim 7, wherein
the oscillation device includes a piezoelectric element, and
the piezoelectric element is used for detection of a residual amount of liquid in the liquid container.

18. The liquid container according to claim 7, wherein
the oscillation device outputs the response signal indicating that there exists liquid in the liquid container regardless of an actual residual amount of liquid in the liquid container.

19. A liquid jetting apparatus on which is mountable a liquid container including an electrical circuit that includes a first electrical device and a second electrical device, a first terminal, a second terminal, and a third terminal, the liquid jetting apparatus comprising:
a first communication processing unit that supplies a reference potential to the second terminal, sends first signals to the first electrical device via the first terminal, and receives second signals from the first electrical device via the third terminal; and
a second communication processing unit that sends and receives third signals via the first terminal and the second terminal to communicates with the second device,
and wherein a voltage of the first signals and a voltage of the third signals have different magnitudes.

20. A liquid jetting system, comprising:
a liquid jetting apparatus; and
a liquid container mountable on the liquid jetting apparatus, the liquid container including:
an electrical circuit having a first electrical device and a second electrical device;
a first terminal;
a second terminal; and
a third terminal,
the electrical circuit being constituted such that the liquid jetting apparatus is able:
to execute sending of signals to the first electrical device and sending of signals to the second electrical device using a terminal potential difference which is a difference between electric potential inputs to the first and second terminals,
to selectively execute either one of the sending of signals to the first electrical device and the sending of signals to the second electrical device by using different magnitudes of the terminal potential difference, and
to execute receiving of signals from the first electrical device via the third terminal.
